(19) United States
(12) Patent Application Publication
(10) Pub. No.: US 2014/0325465 A1
(43) Pub. Date: Oct. 30, 2014

(54) CHIP WITH FLEXIBLE PAD SEQUENCE MANIPULATION AND ASSOCIATED METHOD

(71) Applicant: MStar Semiconductor, Inc., Hsinchu Hsien (TW)

(72) Inventors: Hsin-Cheng Lai, Zhubei City (TW); Yung Chang, Hsinchu City (TW); Chen-Nan Lin, Taipei City (TW); Chung-Ching Chen, Zhubei City (TW); Chen-Hsing Lo, Zhubei City (TW); Shang-Yi Chen, Zhubei City (TW); Cheng-Hsun Liu, Zhubei City (TW)

(73) Assignee: MStar Semiconductor, Inc., Hsinchu Hsien (TW)

(21) Appl. No.: 14/260,410

(22) Filed: Apr. 24, 2014

(30) Foreign Application Priority Data
Apr. 26, 2013 (TW) 102115050

(51) Int. Cl. G06F 17/50

(52) U.S. Cl. CPC G06F 17/5072; G06F 17/5077
USPC 716/119

(57) ABSTRACT

A chip with flexible pad sequence manipulation is provided. The chip can be a memory controller, and includes a hub unit. The hub unit, formed by a gate array, is placed in a hub region predetermined during placing and routing procedures, and is capable of supporting re-placing and re-routing for changing interior interconnections and a pad sequence of the chip.

This application claims the benefit of Taiwan application Serial No. 102115050, filed Apr. 26, 2013, the subject matter of which is incorporated herein by reference.

### BACKGROUND OF THE INVENTION

1. Field of the Invention

The invention relates in general to a chip with flexible pad sequence manipulation and an associated method, and more particularly to a chip capable of supporting regional re-routing by a gate array after tape-out to change interior interconnections and a pad sequence of the chip, and an associated method.

2. Description of the Related Art

Chips (including dies and integrated circuits) are an indispensable hardware foundation of the modern information society. In various electronic devices, different chips are connected by circuit boards to allow the chips to mutually exchange signals and operate in collaboration via routes on the circuit boards, so as to realize overall functions of the electronic devices. For example, a double data rate random access memory (DDR DRAM) is operable with a memory controller, which controls data access of a memory chip in the DDR DRAM.

A chip is provided with multiple pads for signal input and/or output. Via routes on a circuit board, the pads are connected to corresponding pads of another chip, in a way that the two chips may exchange signals via the respective pads. A pad sequence of a chip defines functions of the pads. For example, a pad sequence of a memory controller specifies which pads are to be utilized for outputting data, outputting data strobes and outputting commands.

A layout design process of a chip is in large categorized into a floor plan, placing and routing, and value verification of circuit levels. After successful verification, the layout design can be taped-out and handled over to manufacturers for manufacturing. It should be noted that, after tape-out, the pad sequence of the layout design is confirmed. That is, in current techniques, once the layout design of a chip is taped-out, it is unlikely that the pad sequence in the chip be changed by using regional re-routing.

### SUMMARY OF THE INVENTION

To increase the flexibility of a pad sequence, a chip with flexible pad sequence manipulation is provided by the present invention. The chip includes a signal unit, a hub unit, a multiplexing unit, a parallel-to-serial converting unit, an input/output unit, and a plurality of pads. The signal unit is coupled to a plurality of first nodes, and the multiplexing unit is coupled to a plurality of second nodes. The hub unit is formed by a gate array, and is disposed in a predetermined hub region between the control signal unit and the multiplexing unit. The hub unit connects the first nodes to the second nodes, respectively, and supports re-routing to change a connection correspondence between the first nodes and the second nodes.

The multiplexing unit includes a plurality of multiplexers. The parallel-to-serial converting unit includes a plurality of parallel-to-serial converters. The multiplexers, coupled to multiple associated second nodes and one associated parallel-to-serial converter, select one of the associated second nodes, and conduct the selected second node to the input/output unit via the associated parallel-to-serial converter. Each of the parallel-to-serial converts is coupled to multiple associated multiplexers and the input/output unit, so that a signal of the second node selected by the associated multiplexers may be mutually converted with a signal of the input/output unit.

For example, the foregoing chip may be a memory controller, the signal unit may be a memory control signal unit, and the pads couple to a first memory according to a first pad sequence. After performing a re-routing plan in a hub region of the hub unit, the pads of the chip may couple to a second memory according to a second pad sequence that is different from the first pad sequence.

A method for designing a chip is also provided by the present invention. The method includes: when planning placing and routing in a layout of the chip, predetermining a hub region in the layout to place a gate array therein; and providing a first routing plan in the hub region to realize a pad sequence. When a change in the pad sequence is desired, the first routing plan is removed/discarded, and re-routing is performed in the hub region to provide a second routing plan in a predetermined layout region, and timing verification, e.g., static timing analysis (STA), is again performed for the second routing plan.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a circuit diagram of a chip for different applications;

FIG. 2 is a schematic diagram of a chip with flexible pad sequence manipulation according to an embodiment of the present invention;

FIG. 3 is a schematic diagram of parallel-to-serial signals according to an embodiment of the present invention;

FIG. 4 is a schematic diagram of the chip in FIG. 2 implemented in a different applications according to another embodiment; and

FIG. 5 is a process of a method capable of flexibly changing a pad sequence of a chip according to another embodiment of the present invention.

### DETAILED DESCRIPTION OF THE INVENTION

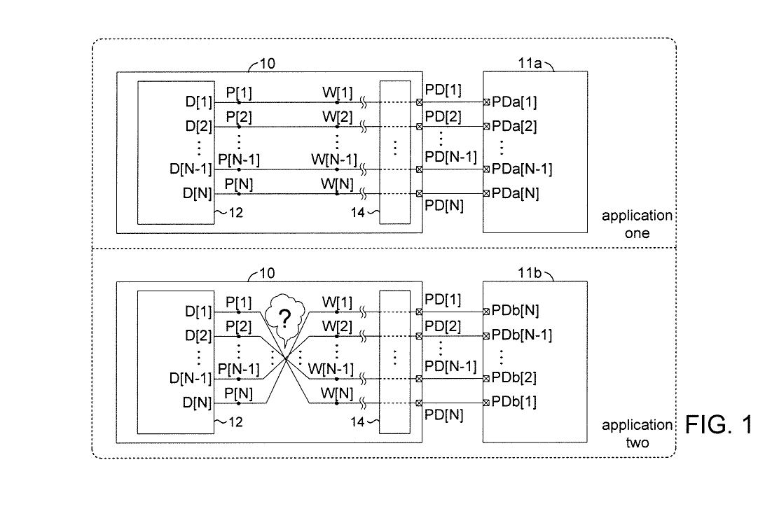

FIG. 1 shows a schematic diagram of a chip 10 to be connected to two chips 11a and 11b for different applications. The chip 10 includes a signal unit 12, an input/output unit 14, and pads PD[1], PD[2] to PD[N−1] and PD[N]. The chip 11a includes pads PDa[1], PDa[2] to PDa[N−1] and PDa[N]. The chip 11b includes pads PDb[1], PDb[2] to PDb[N−1] and PDb[N]. In the chip 10, the signal unit 12 outputs signals D[1] to D[N] to nodes P[1] to P[N], respectively. The input/output unit 14 transceives (transmits and/or receives) signals of the nodes W[1] to W[N] to/from the pads PD[1] to PD[N].

In application one, the pad sequence of the chip 10 is to transmit the signals D[1] to D[N] of the nodes P[1] to P[N] by the pads PD[1] to PD[N], respectively, and so the layout design of the chip 10 is to couple the node P[1] to P[N] to the nodes W[1] to W[N], respectively. The pad sequence of the chip 11a is to continue the signals D[1] to D[N] by the pads PDa[1] to PDa[N], respectively, and so the pads PDa[1] to PDa[N] of the chip 11a are connected to the pads PD[1] to PD[N] of the chip 10 via routes of a circuit board, respectively.

In application two, the pad sequence of the chip 11b is to also continue the signals D[1] to D[N] by the pads PDb[1] to PDb[N], respectively. However, due to various restrictions, e.g., circuit routes, chip packaging, and/or chip positions and arrangements, the pads PDb[1] to PDb[N] need to connect to the pads PD[N] to PD[1] of the chip 10, respectively. Therefore, the pad sequence of the chip 10 needs to be changed to transmit the signals D[1] to D[N] by the pads PD[N] to PD[1], respectively.

To change the pad sequence of the chip 10, the nodes P[1] to P[N] in the chip 10 also need to be coupled to the pads PD[N] to PD[1], respectively. After tape-out of the layout design of the chip 10, positions, circuit structures and routes in the signal unit 12 and the input/output unit 14 in the chip 10 have been verified, and cannot be easily altered—only interconnections between the nodes P[1] to P[N] and the nodes W[1] to W[N] can be modified to change the pad sequence. When modification on regional routes between the nodes P[1] to P[N] and the nodes W[1] and W[N] is desired without altering the layout of other parts (e.g., the signal unit 12 and the input/output unit 14), issues of routing failure and timing verification failure may be caused. Such issues are particularly severe for large values of N. As chip manufacturing processes continue to progress, a total layout area of a chip keeps reducing, resulting in a decreasing space margin for routing in the chip and thus a routing congestion. When routing is modified, lengths of the modified routes are increased, in a way that forces for driving signal transmission (driving capabilities) may become inadequate and signal delay is increased. Further, relative timings between different signals may be deviated from one another. The above issues may lead to a verification failure.

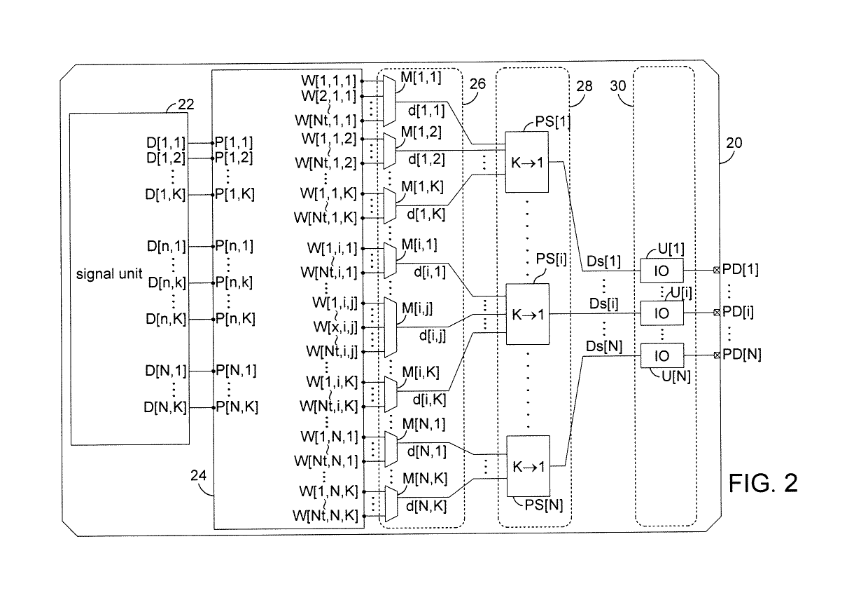

FIG. 2 shows a chip 20 according to an embodiment of the present invention. For example, the chip 20 is a memory controller, and includes a signal unit 22, a hub unit 24, a multiplexing unit 26, a parallel-to-serial converting unit 28, an input/output unit 30, and an N number of pads PD[1] to PD[N]. The signal unit 22 outputs parallel signals D[1, 1], D[1, 2], . . . , D[1, K], . . . , D[n, 1], . . . , D[n, k], . . . , D[n, K] and D[N, 1] to D[N, K] to an N*K number of nodes P[1, 1], P[1, 2], . . . , P[1, K], . . . , P[n, 1], . . . , P[n, k], . . . , P[n, K] and P[N, 1] to P[N, K], respectively. For example, the pads PD[1] to PD[N] may be connected to a memory chip (not shown), and the signal unit 22 may be a memory control signal unit that forms data, command or data strobe signals by the signals D[n, k] (where n=1 to N, and k=1 to K) to control and access the memory chip.

The hub unit 24, formed by a gate array and disposed in a hub region predetermined between the signal unit 22 and the multiplexing unit 26, connects each of the nodes P[n, k] (where n=1 to N, and k=1 to K) to a node W[x, i, j] (where x=1 to Nt, i=1 to N, and j=1 to K).

The multiplexing unit 26 includes an N*K number of multiplexers M[i, j] (where i=1 to N, and j=1 to K), the parallel-to-serial converting unit 28 includes an N number of parallel-to-serial converters PS[i] (where i=1 to N), and the input/output unit 30 includes an N number of input/output cells (IO cells) U[i] (where i=1 to N). The multiplexer M[i, j] is coupled between the nodes W[1, i, j] to W[Nt, i, j] and the parallel-to-serial converter PS[i], selects one node W[x, i, j] from the Nt number of associated nodes W[1, i, j] to W[Nt, i, j], and conducts the signal of the selected node W[x, i, j] as the signal d[i, j], such that the signal d[i, j] is converted by the parallel-to-serial converter PS[i] and conducted to the IO cell U[i]. Each parallel-to-serial converter PS[i] is coupled to a K number of associated multiplexers M[i, 1] to M[i, K] and the IO cell U[i], such that the signals d[i, 1] to d[i, K] of the multiplexers M[i, 1] to M[i, K] may mutually convert with the signal Ds[i] of the IO cell U[i]. The IO cell U[i] is coupled to the pad PD[i], and sends the signal Ds[i] to the pad PD[i] and/or receives the signal of the pad PD[i] as the signal Ds[i].

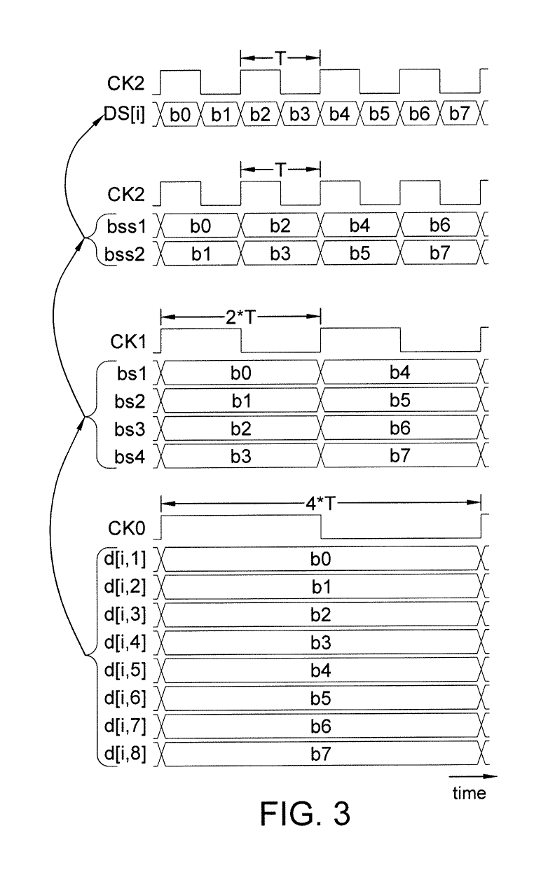

Operations of the parallel-to-serial converter PS[i] in FIG. 2 are illustrated in the embodiment in FIG. 3. Assuming that K=8 in FIG. 3, the parallel-to-serial converter PS[i] performs conversion on eight signals d[i, 1] to d[i, 8] and the signal DS[i], e.g., converting the parallel signals d[i, 1] to d[i, 8] into the serial signal DS[i]. The timings of the signals d[i, 1] to d[i, 8] follow a clock CK0 having a period of (K/2)*T=4*T. That is, the duration of each set of data (e.g., one bit) b0 to b7 in the signals d[i, 1] to d[i, 8] is 4*T. The parallel-to-serial converter PS[i] may serialize the data contents of the signals d[i, 1] to d[i, 5] to a signal bs1 according to the timing of a clock CK1. The period of the clock CK1 is a half of that of the clock CK0, and so one period of the clock CK0 covers two periods of the clock CK1. The parallel-to-serial converter PS[i] may sample the data b0 of the signal d[i, 1] during a period of the clock CK1 to the signal bs1, and sample the data b4 of the signal d[i, 5] in a next period of the clock CK1 to the signal bs1. As such, the data b0 and b4 is sequentially serialized to the signal bs1. Similarly, according to the clock CK1, the parallel-to-serial converter PS[i] may serialize the signals d[i, 2] and d[i, 6] to a signal bs2, the signals d[i, 3] and d[i, 7] to a signal bs3, and the signals d[i, 4] and d[i, 8] to a signal bs4.

Further, the parallel-to-serial converter PS[i] may serialize the signals bs1 and bs3 to a signal bss1 according to the timing of a clock CK2, and the signals bs2 and bs4 to a signal bss2. The period of the clock CK2 is a half of that of the clock CK1, and so one period of the clock CK1 covers two periods of the clock CK2. The parallel-to-serial converter PS[i] may sample the data bs1 during a period of the clock CK2 to serialize the data b0 to the signal bss1, sample the data bs3 in a next period of the clock CK2 to serialize the data b2 to the signal bss1, again sample the signal bs1 in another next period of the clock CK2 to serialize the data b4 to the signal bss1, and again sample the signal bs3 in yet another next period of the clock CK2 to sequentially serialize the data b6 to the signal bss1, and so forth.

The parallel-to-serial converter PS[i] may further serialize the signals bss1 and bss2 into the signal DS[i] according to rising and falling edges of the clock CK2. In each period T of the clock CK2, the parallel-to-serial converter PS[i] may sample the data contents of the signal bss1 during the first half period to the signal DS[i], and alternately sample the data contents of the signal bss2 in the second half period to the signal DS[i]. Thus, the signal DS[i] becomes a high-speed, high-frequency DDR signal. In contrast, the signals d[i, 1] to d[i, K] are low-speed, low-frequency signals. Since the low-speed signals d[i, 1] to d[i, K] are selected from the signals D[1, 1] to D[N, K] of the signal unit 22, the signal d[i, j] and the signal D[n, k] have a consistent speed, meaning that the signal unit 22 is only required to operate in a low-speed. In other words, because the parallel-to-serial converter 26 is capable of performing serial and parallel conversion between low-speed signals and high-speed signals, the requirement of high-speed input/output can be satisfied by the signal unit 22 operating based on a low speed. Such arrangement reduces design limitations of the signal unit 22 while also lowering the power consumption of the signal unit 22. When forming the signal DS[i] from the data b0 to b7, given that the two adjacent sets of data b0 and b1 is equal, b2 and b3 is equal (or the data b1 and b2 is equal, and the data b3 and b4 is equal . . . ), the signal DS[i] may be converted to a single data rate (SDR) signal, e.g., a command signal.

Again referring to FIG. 2, in the multiplexing unit 26, a plurality of different pad sequences can be formed for the chip by connections, selections and switching of the multiplexers M[i, j]. For example, routes of the hub unit 24 may connect the nodes P[n1, 1] to P[n1, K] to the nodes W[1, i0, 1] to W[1, i0, K], respectively, and connect the nodes P[n2, 1] to P[n2, K] to the nodes W[2, i0, 1] to W[2, i0, K], respectively. As the nodes W[1, i0, k] and W[2, i0, k] are coupled to the multiplexer M[i0, K] (where k=1 to K), when the multiplexers M[i0, 1] to M[i0, K] select and conduct the signals of the nodes W[1, i0, 1] to W[1, i0, K] as the signals d[i0, 1] to d[i0, K], the signal DS[i0] of the pad [i0] is formed from serializing the signals D[n1, 1] to D[n1, K]. On the other hand, when the multiplexers M[i0, 1] to M[i0, K] select and conduct the signals of the nodes W[2, i0, 1] to W[2, i0, K] as the signals d[i0, 1] to d[i0, K], the signal DS[i0] of the pad PD[i0] is formed by the signals D[n2, 1] to D[n2, K] instead. Since the signal transmitted by the pad PD[i0] is changed, the pad sequence of the chip 10 is also changed.

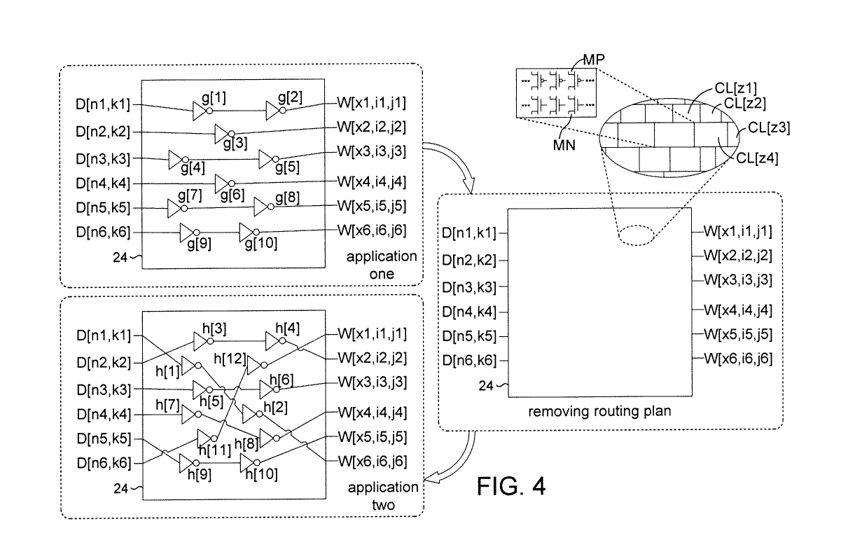

The pad sequence that the multiplexing unit 26 provides is confirmed before tape-out. To offer flexibilities in the pad sequence, the hub unit 24 of the chip 20 is formed by a gate array, so as to support modifications in the pad sequence after tape-out, thereby realizing the pad sequence, which the multiplexing unit 26 is incapable of providing, by re-routing performed by the hub unit 24. In continuation of the embodiment in FIG. 2, FIG. 4 shows re-routing in the hub unit 24 according to one embodiment. The hub unit 24 includes a plurality of adjacent gate array cells (or engineering change order (ECO) cells, e.g., gate array cells CL[z1], CL[z2], CL[z3] and CL[z4]. Each gate array cell CL[.] includes one or more transistors, e.g. n-channel metal oxide semiconductor field effect transistors (MOSFET) MN and p-channel MOSFETs MP that form one or more groups of complementary transistor pairs. When planning the placing and routing of the chip 20 (FIG. 2), in addition to standard cells and IO cells of the signal unit 22, the multiplexing unit 26, the parallel-to-serial converting unit 28 and the input/output unit 30, the gate array cells of the hub unit 24 are also taken into consideration for placing. That is to say, although gate array cells are usually sparingly placed into redundant spaces after placing the standard cells and IO cells, in order to accommodate the gate array cells in a gathered manner, the region where the layout of the hub unit 24 is located is preserved during the placing and routing phase.

With appropriate routing of a metal layer, the transistors in the gate array cells of the hub unit 24 may be combined to form components, e.g., inverters, delayers and/or buffers, for transmitting signals and adjusting the timings of signals. Transistors of a same type and however in different gate array cells may have the same (or similar) transistor characteristics (e.g., the channel width or length), and may thus form components located at different positions and however having the same component characteristics (e.g., gate delay and/or signal driving capabilities). By gathering transistors of different quantities, various components having different component characteristics may be formed. Therefore, the hub unit 24 is capable of providing a hub region that allows free re-placing and re-routing after tape-out.

For example, in the layout design of application one, the nodes D[n1, k1] to D[n6, k6] of the signal unit 22 (FIG. 2) are expectedly coupled to the nodes W[x1, i1, j1] to W[x6, i6, j6] of the multiplexing unit 26 (FIG. 2), respectively. Therefore, in the layout design of the chip 20, components g[1] to g[10] may be formed by an appropriating routing plan in the hub unit 24 according to timing requirements, such that the nodes D[n1, k1] to D[n6, k6] may be coupled to the nodes W[x1, i1, j1] to W[x6, i6, j6], respectively. After the verification and tape-out of the layout design of application one, in the event that the nodes D[n1, k1] and D[n6, k6] are required to couple to the nodes W[x6, i6, j6] and W[x1, i1, j1] according to application two due to a change in the chip specification (e.g., the pad sequence), the original routing plan in the hub unit 24 may be removed to restore the hub unit 24 to a state before placing the components and before routing. According to the timing requirements of the signals of the nodes, re-routing is performed in the hub unit 24 to form new components h[1] to h[12] and new signal transmission interconnections by a new routing plan. For example, the total signal driving capability of the components h[1] and h[2] may be greater than that of the components g[1] and g[2] to overcome a longer distance between the node D[n1, k1] to the node W[x6, i6, j6]. For example, as the components in the hub unit 24 may be re-placed, the issue of a routing congestion can be solved. As shown in FIG. 4, in application one and application two, same or different quantities of components g[.] and d[.] may be formed in the hub unit 24. The components g[.] and d[.] may be distributed at the same or different locations, and may have the same or different component characteristics.

When changing the layout design of application one to the layout design of application two by performing re-placing and re-routing in the hub unit 24, only the routing plan in the hub unit 24 needs to be changed while the layout designs of the other circuits (e.g., the signal unit 22, the multiplexing unit 26, the parallel-to-serial converting unit 28, and the input/output unit 30) need not be modified. Therefore, modifications to be made after tape-out only involve regional changes in the layout design of the hub unit 24, thereby preventing time and design resources consumed by large-scale layout changes.

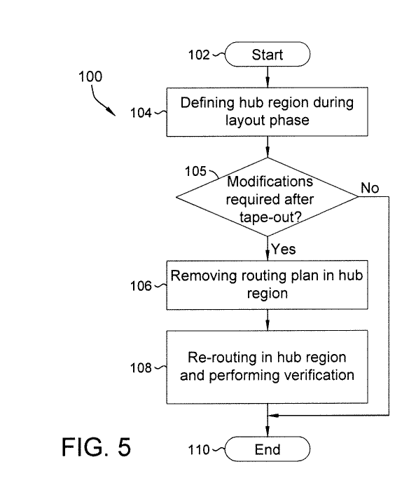

FIG. 5 shows a process 100 of a method for flexibly modifying a pad sequence of the chip 20 (FIG. 2) according to an embodiment of the present invention. Steps of the process 100 are described below.

The process 100 begins in step 102.

In step 104, a layout design of the chip 20 is performed. The layout design includes a floor plan, placing and routing. An electronically designed, automated software tool may be employed for automatic placing and routing. When performing placing and routing, standard cells and/or IO cells may be placed according to functional requirements of the signal unit 22, the multiplexing unit 26, the parallel-to-serial converting unit 28 and the input/output unit 30 to realize these units. Meanwhile, in the layout of the chip 20, a hub region is preserved for placing a gate array therein to form the hub unit 24, e.g., for placing a plurality of gate array cells. The overall routing may then be performed for the standard cells, the IO cells and the gate array cells in the chip. After the placing and routing, the hub region where the hub unit 24 is located has a routing plan, which may collaborative provide one or more pad sequences with the multiplexing unit 26. Verification is then performed for the re-placed and re-routed layout design, and the chip 20 can then be taped-out.

In step 105, step 106 is performed when a modification is needed after tape-out, or else step 110 is performed.

In step 106, when a modification is needed after taping-out the layout design of the chip 20, e.g., updating the pad sequence to a pad sequence that is not supported by the original layout design (i.e., the layout design completed in step 104), the original routing plan in the hub region of the layout design from step 104 is removed to restore the hub region where the hub unit 24 is located to a component-free, routing-free region.

In step 108, re-routing is performed in the hub region. New components and interconnections are formed by the new routing plan to support requirements of the new pad sequence. In step 108, only the routing plan within the hub region is changed while the layout outside the hub region is kept unchanged. For example, the layout designs of the signal unit 22, the multiplexing unit 26, the parallel-to-serial converting unit 28 and the input/output unit 30 are kept unchanged. Therefore, predetermined and existing functions as well as timings of other circuits outside the hub region are unaffected. The timing verification is again performed for the chip layout design that is re-routed. Preferably, the timing verification includes static timing analysis (STA) to ensure that setup time and hold time may operate according to correct frequencies.

In step 110, the entire layout design of the chip 20 is complete.

In the present invention, a hub region is preserved in a chip to provide a gate array in a gathered manner to further support changes in a pad sequence after tape-out. Therefore, the present invention is capable of expanding modification flexibilities after tape-out and allowing similar layout designs to be extensively applied in various different applications. Further, by limiting the layout modifications occurring after tape-out in the hub region, the scale, resources, time and costs for the layout modifications are reduced.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A chip with flexible pad sequence manipulation, comprising:
a signal unit, coupled to a plurality of first nodes;
an input/output unit, coupled between a plurality of second nodes and a plurality of pads; and
a hub unit, formed by a gate array, disposed between the signal unit and the input/output unit, configured to connect each of the first nodes to one of the second nodes, and to support re-routing to change a connection correspondence between the first nodes and the second nodes.

2. The chip according to claim 1, further comprising:
a plurality of multiplexers, each configured to select one node from at least a portion of the second nodes to be conducted to the input/output unit.

3. The chip according to claim 2, further comprising:
a parallel-to-serial converter, coupled between the multiplexers and the input/output unit, configured to convert signals of the second nodes selected by the multiplexers and output the converted signals to the input/output unit.

4. The chip according to claim 1, wherein the pads are coupled to a first memory according to a first pad sequence.

5. The chip according to claim 4, wherein the re-routing couples the pads to a second memory according to a second pad sequence, and the first pad sequence and the second pad sequence are different.

6. The chip according to claim 4, wherein the signal unit is a memory control signal unit.

7. The chip according to claim 1, wherein the re-routing comprises timing verification.

8. The chip according to claim 7, wherein the timing verification comprises static timing analysis (STA).

9. A method capable of flexibly modifying a pad sequence of a chip, comprising:
when performing placing and routing in a layout of the chip, predetermining a hub region in the layout to place a gate array, and providing a first routing plan for realizing the pad sequence; and
to change the pad sequence, performing re-routing in the hub region to provide a second routing plan in the predetermined layout region.

10. The method according to claim 9, wherein the step of performing the re-routing in the hub region further comprises removing the first routing plan.

11. The method according to claim 9, wherein the chip is a memory controller.

12. The method according to claim 9, wherein the step of performing the re-routing in the predetermined hub region further comprises performing timing verification.

13. The method according to claim 12, wherein the timing verification comprises performing STA.
